(19) United States
(12) Patent Application Publication
(10) Pub. No.: US 2022/0032429 A1
(43) Pub. Date: Feb. 3, 2022

(54) Wrench Extension Apparatus

(71) Applicant: Carl Fausett, Horicon, WI (US)

(72) Inventor: Carl Fausett, Horicon, WI (US)

(21) Appl. No.: 17/387,828

(22) Filed: Jul. 28, 2021

Related U.S. Application Data
(60) Provisional application No. 63/057,798, filed on Jul. 28, 2020.

(51) Int. Cl. B25B 23/16; B25G 1/06; B25G 3/12

(52) U.S. Cl. CPC B25B 23/16; B25G 3/12; B25G 1/063

(57) ABSTRACT

A wrench extension apparatus is an apparatus that serves to extend the moment arm of a wrench to increase the leverage on a mechanical fastener, so that the mechanical fastener is fastened or loosened easily without much effort from the user. The apparatus may include a breaker bar, at least one proximal protrusion, and at least one distal protrusion. The breaker bar increases the moment arm of a wrench to increase the torque being applied to the mechanical fastener. The breaker bar is also designed to be comfortably gripped without hurting the user's hand. The at least one proximal protrusion and the at least one distal protrusion enable the breaker bar to be engaged with the desired wrench. Further, the at least one proximal protrusion and the at least one distal protrusion enable the breaker bar to be used with wrenches of different sizes without the need to switch wrenches.

The current application claims a priority to the U.S. provisional patent application Ser. No. 63/057,798 filed on Jul. 28, 2020.

### FIELD OF THE INVENTION

The present invention generally relates to work tools and tool accessories. More specifically, the present invention provides a wrench extension apparatus that can be used as a breaker bar for wrenches.

### BACKGROUND OF THE INVENTION

Fastening or loosening different mechanical fasteners can be a difficult task due to different factors. For example, old rusty screws or nuts can be difficult to loosen up using normal tools such as a socket wrench. Similarly, fastening a screw or other similar mechanical fasteners in tight or hard-to-reach spaces can be difficult using traditional tools. In those cases, the user must utilize additional tools to help with the task at hand, such as a breaker bar. A breaker bar is generally an elongated tubular device that increases the moment arm of a wrench to increase the torque being applied onto the mechanical fastener. Breaker bars are common tools used in different applications, but most only work with specific tools such as socket wrenches. What to do when a socket wrench cannot be used? An option is to use a normal wrench, but most wrenches are not long enough to provide the necessary torque. In addition, many wrenches, especially open-ended wrenches, cannot be used with a breaker bar. Therefore, there is a need for an apparatus that can be used as breaker bar with different types of wrenches including socket end wrenches, open-end wrenches, closed-end wrenches, etc.

The proposed invention is a wrench extension apparatus preferably referred to as a “wrench extension,” or a “breaker bar” or a “cheater bar” depending on local colloquialisms. It can be used to extend the moment arm of any wrench so that users can get more leverage on a nut or bolt. A wrench is simply engaged with the desired nut or bolt and the wrench extension is secured to the other end of the wrench. Then, the user can pull or push on the wrench extension to easily fasten or loosen the nut or bolt. The present invention is preferably made of steel and provides several different sized engagement points to engage with wrenches of different sizes. Furthermore, the several engagement points can be provided in either the metric version or the Society of Automotive Engineers (SAE) inch version. Additional features and benefits are further discussed in the sections below.

### SUMMARY OF THE INVENTION

The present invention is a wrench extension or breaker bar apparatus designed to to increase the torque being applied onto a mechanical fastener through a wrench that is attached to that mechanical fastener. The present invention is designed to be used with different types of wrenches, such as open-ended wrenches, box-ended wrenches, socket wrenches, etc. Furthermore, the present invention is designed to accommodate different wrench sizes so that the user does not have to switch tools when working on a project.

### BRIEF DESCRIPTION OF THE DRAWINGS

FIG. 1 is a top front perspective view showing the present invention.

FIG. 2 is a bottom rear perspective view showing the present invention.

FIG. 3 is a side view showing the present invention.

FIG. 4 is an enlarged rear view showing the distal bar end of the present invention.

FIG. 5 is a magnified side view showing the proximal bar end of the present invention.

FIG. 6 is a magnified side view showing the distal bar end of the present invention.

FIG. 7 is a top view showing the present invention, wherein a user's hand is shown pulling on the breaker bar, and wherein the first proximal protrusion of the plurality of proximal protrusions is shown engaged with a box-ended wrench.

### DETAIL DESCRIPTIONS OF THE INVENTION

All illustrations of the drawings are for the purpose of describing selected versions of the present invention and are not intended to limit the scope of the present invention.

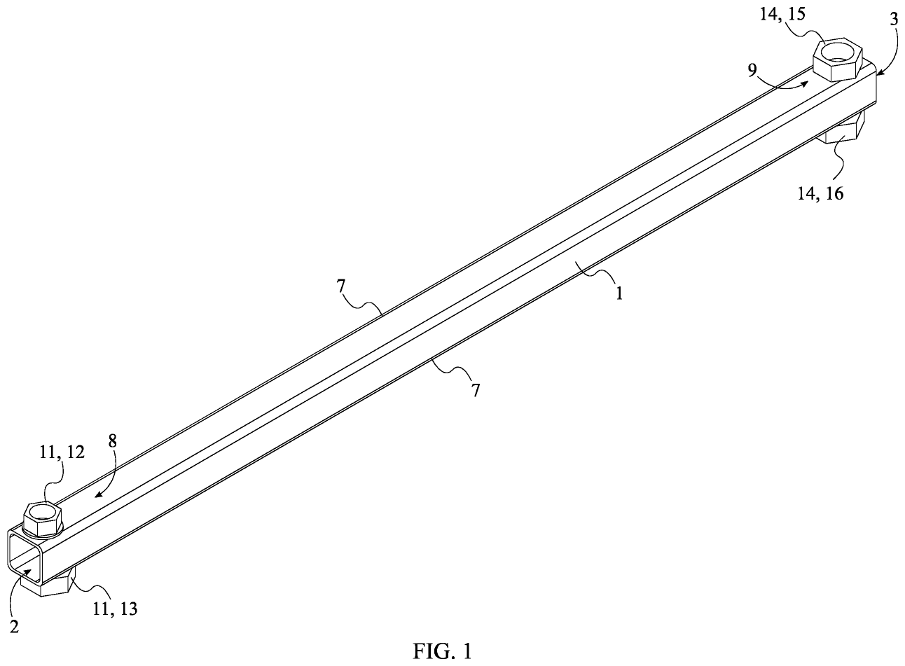

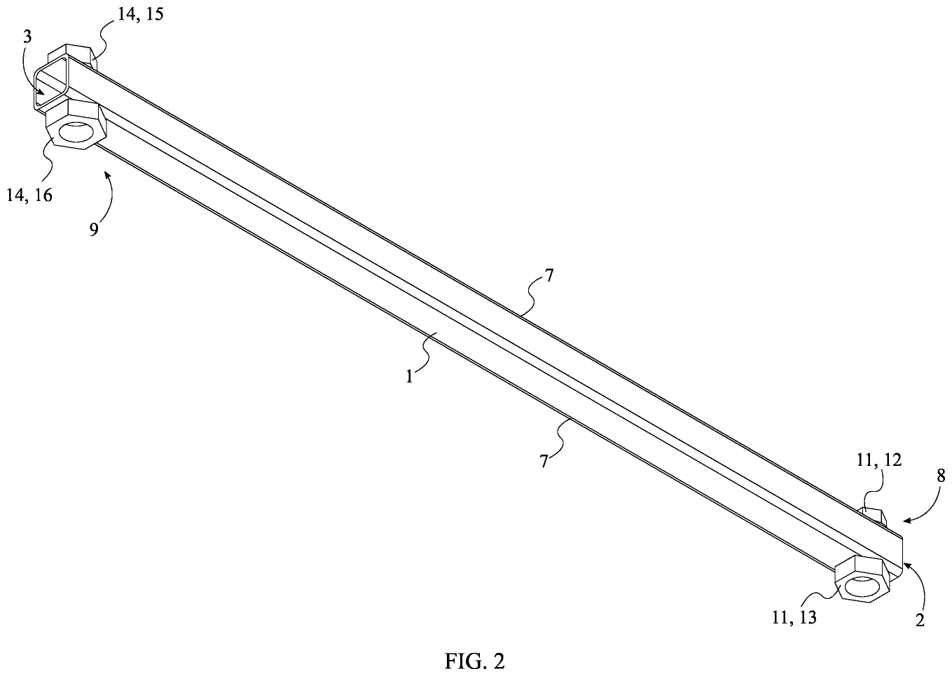

The present invention is a wrench extension apparatus that serves to extend the moment arm of a wrench to increase the leverage on a mechanical fastener, so the mechanical fastener is fastened or loosened easily without much effort from the user. As can be seen in FIGS. 1 and 2, the present invention may comprise a breaker bar 1, at least one proximal protrusion 8, and at least one distal protrusion 9. The breaker bar 1 increases the moment arm of a wrench to increase the torque being applied onto the mechanical fastener. The breaker bar 1 is also designed to be comfortably gripped by the user without hurting the user's hand. The at least one proximal protrusion 8 and the at least one distal protrusion 9 enable the breaker bar 1 to be engaged with the desired wrench without the need of additional tools. Further, the at least one proximal protrusion 8 and the at least one distal protrusion 9 enable the breaker bar 1 to be used with wrenches of different sizes.

The general configuration of the aforementioned components enables users to easily fasten or loosen a desired mechanical fastener using the appropriate wrench without having to switch tools. As can be seen in FIG. 1 through 3, the breaker bar 1 is preferably an elongated tubular structure that is long enough to sufficiently increase the moment arm of the desired wrench. However, the breaker bar 1 may also be a solid structure when desired for greater structural strength. Due to its elongated structure, the breaker bar 1 comprises a proximal bar end 2 and a distal bar end 3 that correspond to the terminal ends of the breaker bar 1. Further, to ensure that the maximum length 6 of the breaker bar 1 is used to increase the moment arm of the wrench, the at least one proximal protrusion 8 is positioned adjacent to the proximal bar end 2. Likewise, the at least one distal protrusion 9 is positioned adjacent to the distal bar end 3. The positioning of the at least one proximal protrusion 8 and the at least one distal protrusion 9 ensures that the moment arm of the wrench is as large as possible whether the wrench is engaged with the at least one proximal protrusion 8 or the at least one distal protrusion 9. Furthermore, the at least one proximal protrusion 8 and the at least one distal protrusion 9 are laterally mounted onto the breaker bar 1 so that the breaker bar 1 can be positioned parallel to the wrench when the wrench is engaged to either the at least one proximal protrusion 8 or the at least one distal protrusion 9. Moreover, the at least one proximal protrusion 8 and the at least one distal protrusion 9 is each shaped to interlock with a corresponding engagement point of a wrench to ensure that when force is applied to the breaker bar 1, the wrench does not disengage from the at least one proximal protrusion 8 or the at least one distal protrusion 9. Finally, to prevent twisting of the wrench as force is applied on the breaker bar 1, a central axis 10 of the at least one proximal protrusion 8 and a central axis 10 of the at least one distal protrusion 9 is positioned perpendicular to a length 6 of the breaker bar 1. This ensures that any torque is transmitted properly to the mechanical fastener through the wrench to loosen or fasten the fastener.

As previously discussed, the present invention can be utilized with wrenches of different sizes and standards (i.e., metric or SAE/inch). To do so, the at least one proximal protrusion 8 may be a plurality of proximal protrusions 11 that include proximal protrusions of different sizes and standards to match wrenches of different sizes and standards. As can be seen in FIG. 1 through 4, the plurality of proximal protrusions 11 is radially positioned around the proximal bar end 2 so that the user can easily engage the wrench with the appropriate proximal protrusion. Further, in one embodiment, the plurality of proximal protrusions 11 may comprise a first proximal protrusion 12 and a second proximal protrusion 13. The first proximal protrusion 12 and the second proximal protrusion 13 provide engagement protrusions of different dimensions to accommodate two different sizes of wrenches. The first proximal protrusion 12 and the second proximal protrusion 13 are positioned opposite to each other about the proximal bar end 2 so that the wrench can be easily engaged with the first proximal protrusion 12 or the second proximal protrusion 13. Furthermore, in one embodiment, the first proximal protrusion 12 is preferably a M8 high-strength flange nut fastener, with the flange portion being preferably welded onto the proximal bar end 2. On other hand, the second proximal protrusion 13 is preferably a M12 high-strength nut fastener. This enables the present invention to be used with two different wrench ends corresponding to the M8 and the M12 nut fasteners. In other embodiments, different nut fasteners can be used for the first proximal protrusion 12 and/or the second proximal protrusion 13. Further, additional proximal protrusions can be provided around the proximal bar end 2 to accommodate additional wrench sizes.

Similar to the at least one proximal protrusion 8, multiple distal protrusions can be provided to accommodate additional wrench sizes and standards. To do so, the at least one distal protrusion 9 may be a plurality of distal protrusions 14 that include distal protrusions of different sizes to match wrenches of different dimensions. As can be seen in FIG. 1 through 4, the plurality of distal protrusions 14 is radially positioned around the distal bar end 3 so that the user can easily engage the wrench with the appropriate distal protrusion. Further, in one embodiment, the plurality of distal protrusions 14 may comprise a first distal protrusion 15 and a second distal protrusion 16. The first distal protrusion 15 and the second distal protrusion 16 provide engagement protrusions of different dimensions to accommodate two additional different sizes of wrenches. The first distal protrusion 15 and the second distal protrusion 16 are positioned opposite to each other about the distal bar end 3 so that the wrench can be easily engaged with the first distal protrusion 15 or the second distal protrusion 16. Furthermore, in one embodiment, the first distal protrusion 15 is preferably a M10 high-strength nut fastener. On other hand, the second distal protrusion 16 is preferably a M14 high-strength nut fastener. This enables the present invention to be used with two different wrench ends matching the M10 and the M14 nut fasteners. In other embodiments, different nut fasteners can be used for the first distal protrusion 15 and/or the second distal protrusion 16. Further, additional distal protrusions can be provided around the distal bar end 3 to accommodate additional wrench sizes.

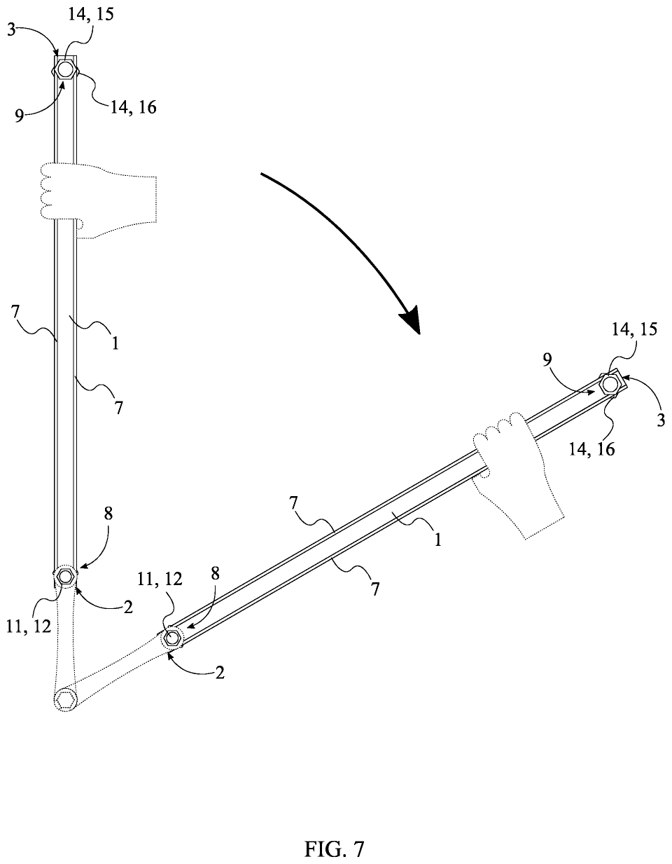

To increase the overall structural strength of the present invention, the breaker bar 1, the at least one proximal protrusion 8, and the at least one distal protrusion 9 may be made of steel. This prevents undesired twisting of the present invention even under great stress from the loads being applied on the breaker bar 1. Thus, as can be seen in FIG. 7, the user can freely pull or push on the breaker bar 1 to loosen stuck mechanical fasteners or to tightly fasten critical mechanical fasteners. In other embodiments, different materials can be utilized to decrease the overall weight of the present invention or to further increase the structural strength of the present invention, such as making the breaker bar 1 a solid structure instead of a tubular structure.

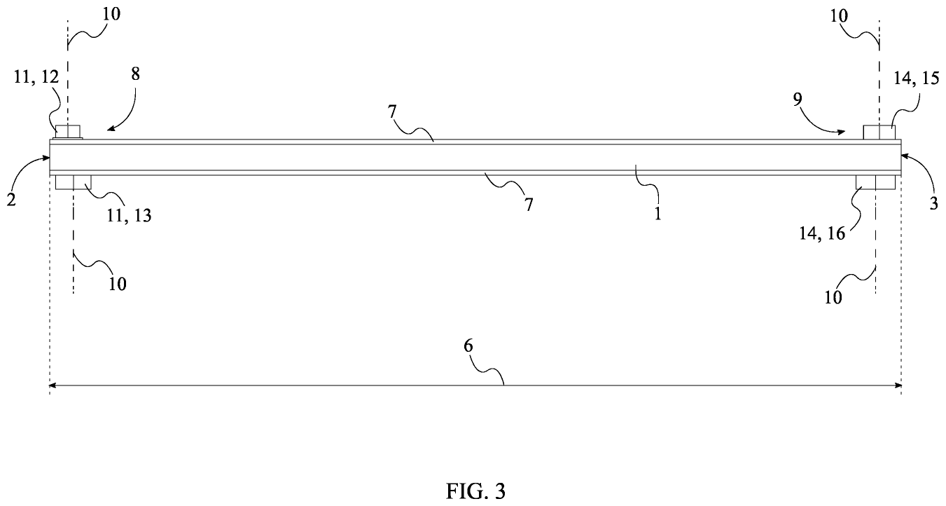

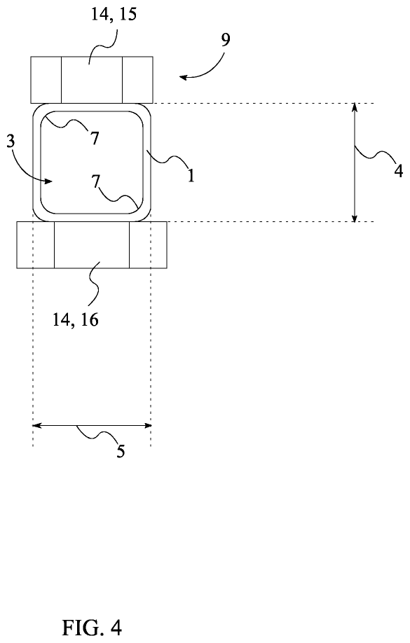

Furthermore, to enable the present invention to be used with socket wrenches and other similar wrenches, the breaker bar 1 may be a polygonal tubular bar that can be utilized as a common breaker bar. As can be seen in FIGS. 3 and 4, the breaker bar 1 comprises a plurality of longitudinal exterior corner edges 7 due to the polygonal cross-sectional shape of the breaker bar 1. Further, each of the plurality of longitudinal exterior corner edges 7 is a rounded edge to make gripping on the breaker bar 1 as comfortable as possible. The rounded edges of the breaker bar 1 also enable the user to grip onto the breaker bar 1 without wearing special protection, such as work gloves. Furthermore, the polygonal tubular bar may be a square tubular bar. In other embodiments, the breaker bar 1 may have different polygonal shapes with non-rounded edges. In alternate embodiments, the breaker bar 1 may be a telescopic or modular bar that can be shortened or lengthened as necessary.

In one embodiment, the present invention is designed to be long enough to be used for vehicle maintenance. So, as can be seen in FIGS. 3 and 4, a height 4 of the breaker bar 1 and a width 5 of the breaker bar 1 may be equal to each other, and a ratio between the height 4 of the breaker bar 1 or the width 5 of the breaker bar 1 and a length 6 of the breaker bar 1 may be 1:72. For example, the width 5 of the breaker bar 1 is preferably 0.75 inches, the height 4 of the breaker bar 1 is also 0.75 inches, and the length 6 of the breaker bar 1 is 18 inches. In other embodiments, the breaker bar 1 may have different dimensions to accommodate deeper spaces.

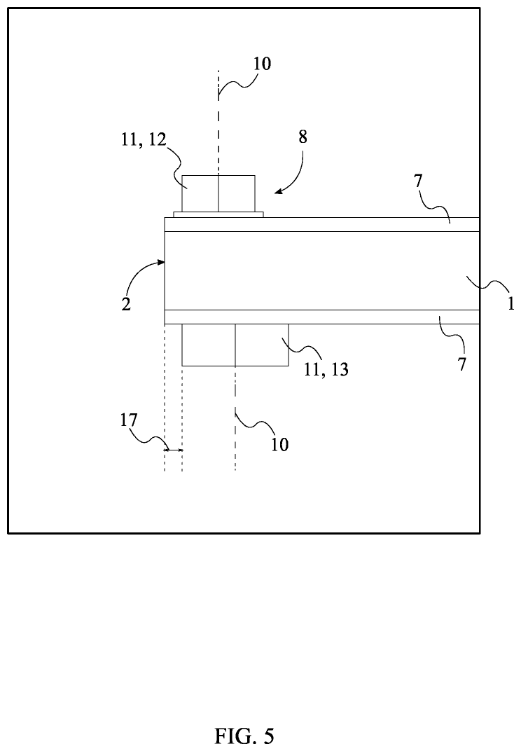

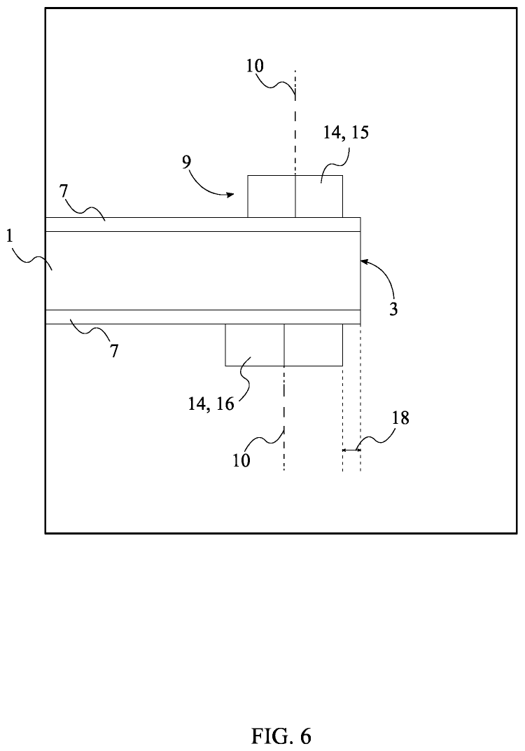

To further prevent the breaker bar 1 from bending when the torque is applied on the fastener via the wrench, the at least one proximal protrusion 8 and the at least one distal protrusion 9 may not be mounted directly on the edge of the corresponding bar end. As can be seen in FIGS. 5 and 6, the at least one proximal protrusion 8 may be positioned offset from the proximal bar end 2 by a proximal clearance gap 17. Further, the proximal clearance gap 17 is preferably 0.125 inches. Likewise, the at least one distal protrusion 9 may be positioned offset from the distal bar end 3 by a distal clearance gap 18. The distal clearance gap 18 is also preferably 0.125 inches. Thus, any stress is minimized on the proximal bar end 2 and the distal bar end 3 to prevent bending of the proximal bar end 2 and the distal bar end 3. In other embodiments, the proximal clearance gap 17 and the distal clearance gap 18 can include different lengths.

In an exemplary embodiment, the user first secures a wrench of a size matching the size of the mechanical fastener to be fastened/removed. As can be seen in FIG. 7, the user connects the appropriate end of the wrench to the mechanical fastener, leaving the other end free to engage with the appropriate proximal protrusion or the appropriate distal protrusion. Since the present invention accommodates both open ends and boxed ends of a wrench, the user does not have to worry about which end to leave free for the present invention to be engaged to. Then, the user engages the present invention to the wrench using the matching protrusion of the at least one proximal protrusion 8 or the at least one distal protrusion 9. Then, the user can pull or push on the breaker bar 1 to apply leverage against the mechanical fastener until the mechanical fastener loosens. Once the nut or bolt loosens, the user can remove the present invention from the work area to completely remove the mechanical fastener.

Although the invention has been explained in relation to its preferred embodiment, it is to be understood that many other possible modifications and variations can be made without departing from the spirit and scope of the invention.

What is claimed is:

1. A wrench extension apparatus comprising:
a breaker bar;
at least one proximal protrusion;
at least one distal protrusion;
the breaker bar comprising a proximal bar end and a distal bar end;
the at least one proximal protrusion being positioned adjacent to the proximal bar end;
the at least one distal protrusion being positioned adjacent to the distal bar end;
the at least one proximal protrusion and the at least one distal protrusion being laterally mounted onto the breaker bar;
the at least one proximal protrusion and the at least one distal protrusion being shaped to interlock with a corresponding engagement point of a wrench; and,
a central axis of the at least one proximal protrusion and a central axis of the at least one distal protrusion being positioned perpendicular to a length of the breaker bar.

2. The wrench extension apparatus as claimed in claim 1 comprising:
the at least one proximal protrusion being a plurality of proximal protrusions; and,
the plurality of proximal protrusions being radially positioned around the proximal bar end.

3. The wrench extension apparatus as claimed in claim 2 comprising:
the plurality of proximal protrusions comprising a first proximal protrusion and a second proximal protrusion; and,
the first proximal protrusion and the second proximal protrusion being positioned opposite to each other about the proximal bar end.

4. The wrench extension apparatus as claimed in claim 3, wherein the first proximal protrusion is a M8 high-strength flange nut fastener.

5. The wrench extension apparatus as claimed in claim 3, wherein the second proximal protrusion is a M12 high-strength nut fastener.

6. The wrench extension apparatus as claimed in claim 1 comprising:
the at least one distal protrusion being a plurality of distal protrusions; and,
the plurality of distal protrusions being radially positioned around the distal bar end.

7. The wrench extension apparatus as claimed in claim 6 comprising:
the plurality of distal protrusions comprising a first distal protrusion and a second distal protrusion; and,
the first distal protrusion and the second distal protrusion being positioned opposite to each other about the distal bar end.

8. The wrench extension apparatus as claimed in claim 7, wherein the first distal protrusion is a M10 high-strength nut fastener.

9. The wrench extension apparatus as claimed in claim 7, wherein the second distal protrusion is a M14 high-strength nut fastener.

10. The wrench extension apparatus as claimed in claim 1, wherein the breaker bar, the at least one proximal protrusion, and the at least one distal protrusion are made of steel.

11. The wrench extension apparatus as claimed in claim 1 comprising:
the breaker bar being a polygonal tubular bar;
the breaker bar comprising a plurality of longitudinal exterior corner edges; and,
each of the plurality of longitudinal exterior corner edges being a rounded edge.

12. The wrench extension apparatus as claimed in claim 11, wherein the polygonal tubular bar is a square tubular bar.

13. The wrench extension apparatus as claimed in claim 1, wherein a height of the breaker bar and a width of the breaker bar are equal to each other, and wherein a ratio between the height of the breaker bar or the width of the breaker bar and a length of the breaker bar is 1:72.

14. The wrench extension apparatus as claimed in claim 13, wherein the height of the breaker bar is 0.75 inches.

15. The wrench extension apparatus as claimed in claim 13, wherein the width of the breaker bar is 0.75 inches.

16. The wrench extension apparatus as claimed in claim 13, wherein the length of the breaker bar is 18 inches.

17. The wrench extension apparatus as claimed in claim 1, wherein the at least one proximal protrusion is positioned offset from the proximal bar end by a proximal clearance gap.

18. The wrench extension apparatus as claimed in claim 17, wherein the proximal clearance gap is 0.125 inches.

19. The wrench extension apparatus as claimed in claim 1, wherein the at least one distal protrusion is positioned offset from the distal bar end by a distal clearance gap.

20. The wrench extension apparatus as claimed in claim 19, wherein the distal clearance gap is 0.125 inches.
